(19) United States
(12) Patent Application Publication
(10) Pub. No.: US 2006/0119730 A1
(43) Pub. Date: Jun. 8, 2006

(54) Image pickup module

(75) Inventors: Satoshi Shiraishi, Nagano-shi (JP); Tominari Kojima, Nagano-shi (JP)

Correspondence Address: RANKIN, HILL, PORTER & CLARK LLP, 4080 ERIE STREET, WILLOUGHBY, OH, 44094-7836, US

(73) Assignee: Shinko Electric Industries Co., Ltd., Nagano-shi (JP)

(21) Appl. No.: 11/295,342

(22) Filed: Dec. 6, 2005

(30) Foreign Application Priority Data
Dec. 7, 2004 (JP) 2004-353881

(51) Int. Cl. H04N 5/225

(52) U.S. Cl. 348/342

(57) ABSTRACT

In an image pickup module, a substrate, on which an image pickup element is mounted, is mounted-in a-casing portion of a holder, which includes a barrel portion supporting a light receiving lens and also includes the casing portion, by aligning a light receiving surface of the image pickup element with the light receiving lens. The holder is provided with a partitioning wall adapted to partition off a region, on which the image pickup element is mounted, on the substrate from outer regions.

The present application claims foreign priority based on Japanese Patent Application No. 2004-353881, filed Dec. 7, 2004, the content of which is incorporated herein by reference.

### BACKGROUND OF THE INVENTION

1. Technical Field

The present invention relates to an image pickup module, on which an image pickup element is mounted, for use in an image pickup apparatus.

2. Related Art

An image pickup module, on which an image pickup element, such as a CCD or a CMOS, is mounted, may cause troubles that sometimes, dust, which remains in the image pickup module, adheres to a surface of the image pickup element or to a surface of an optical component, such as an optical filter mounted in the image pickup module, during or after the assembly of a product, and that the dust appears as black spots on an image.

Such troubles fairly frequently occur due to the adherence to the dust to the surface of an image pickup element or an optical component in products of the image pickup module. Thus, a method of performing an operation of assembling products in a clean room and a method of assembling products by removing dust from substrates are performed as a method of preventing occurrences of troubles due to adherence of dust.

Incidentally, a method of mounting an image pickup element by using an underfill material so that a light receiving portion faces a through hole of a substrate, thereby preventing dust from adhering to a light receiving surface of the image pickup element after the assembly of the image pickup module, has been developed as a method of preventing the influence of dust in an image pickup module (see JP-A-2004-235547). Also, a method of sealing an image pickup element to a ceramic substrate by using an underfill material and of mounting an optical filter on the ceramic substrate in contraposition to the image pickup element, thereby tightly sealing a light receiving portion of the image pickup element, has been developed (see JP-A-2004-29590).

As described above, in the products of an image pickup module, the trouble of appearance of black dots on an image due to the adherence of dust on the surface of the image pickup element is unignorable. Thus, a manufacturing method has been reviewed. However, it is difficult to surely remove dust. Therefore, it is not sufficient to review a manufacturing method and a manufacturing process.

Further, in cases where the product of the image pickup module is configured so that the light receiving surface of the image pickup element is not completely airtightly sealed, and where the image pickup element is mounted on a control board and is accommodated in a holder for the image pickup module, countermeasures to prevent occurrence of a trouble due to dust, which correspond to the product of the image pickup module, are needed.

### SUMMARY OF THE INVENTION

The invention is accomplished to prevent occurrence of such a trouble due to dust in the image pickup module. An object of the invention is to provide an image pickup module enabled to prevent dust from adhering to the surfaces of the image pickup element and the optical component during the manufacturing process or after the manufacture of the product, thereby suppressing occurrence of a trouble due to dust.

To achieve the foregoing object of the invention, according to an aspect of the invention, there is provided an image pickup module (hereunder referred to as a first image pickup module of the invention), wherein a substrate, on which an image pickup element is mounted, is attached to a casing portion of a holder, which includes the casing portion and a barrel portion adapted to support a light receiving lens, by aligning a light receiving surface of the image pickup element with the light receiving lens. The first image pickup module of the invention features that a partitioning wall adapted to partition a region, on which the image pickup element is mounted, on the substrate from an outer region is provided in at least one of the holder and the substrate.

Further, an embodiment (hereunder referred to as a second image pickup module) of the first image pickup module features that the partitioning wall is extended from an inner surface of the casing portion toward the substrate.

Furthermore, an embodiment (hereunder referred to as a third image pickup module) of the first or second image pickup module features that an infrared ray cut filter is provided on an inner surface of the casing portion by being placed to face the light receiving lens and to seal an opening hole of the barrel portion, and that the partitioning wall is disposed outside a region in which the filter is placed.

Additionally, an embodiment of one of the first to third image pickup modules features that the partitioning wall partitions the outer region of the region, on which the image pickup element is mounted, into a plurality of regions. Consequently, the invention can more effectively prevent dust from adhering to the image pickup element, and the like.

According to another aspect of the invention, there is provided an image pickup module (hereunder referred to as a fourth image pickup module of the invention), wherein a substrate, on which an image pickup element is mounted is attached to a casing portion of a holder, which includes the casing portion and a barrel portion adapted to support a light receiving lens, by aligning a light receiving surface of the image pickup element with the light receiving lens. The fourth image pickup module of the invention features that an infrared ray cut filter is provided on an inner surface of the casing portion by being placed to face the light receiving lens and to seal an opening hole of the barrel portion, and that an inner surface of the casing portion in an outer region of a region, in which the filter is disposed, is sealed with a resin.

According to still another aspect of the invention, there is provided an image pickup module (hereunder referred to as a fifth image pickup module of the invention), wherein a substrate, on which an image pickup element is mounted, is attached to a casing portion of a holder, which includes the casing portion and a barrel portion adapted to support a light receiving lens, by aligning a light receiving surface of the image pickup element with the light receiving lens. The fifth image pickup module of the invention features that an outer region of a region on which the image pickup element is mounted, on the substrate is sealed with a resin.

An embodiment of the fourth or fifth image pickup module of the invention features that a resin material having stickiness is used as the resin used for sealing.

The image pickup module according to the invention can suppress dust which adheres to the inner surface of the components, from being moved and adhering to the light receiving surface of the image pickup element by being peeled or falling from the components. Consequently, occurrence of a trouble due to dust can be prevented. Thus, the yield of the product can be enhanced. Also, the fraction defective of the product can be reduced.

### BRIEF DESCRIPTION OF THE DRAWINGS

FIG. 1 is a cross-sectional view illustrating the configuration of a first embodiment of an image pickup module.

FIG. 2 is a plan view illustrating a substrate.

FIG. 3 is a cross-sectional view illustrating the configuration of a second embodiment of an image pickup module.

FIG. 4 is a bottom view illustrating a holder of the second embodiment.

FIG. 5 is a plan view illustrating a substrate of the second embodiment.

FIG. 6 is a cross-sectional view illustrating the configuration of a related-art image pickup module.

### DETAILED DESCRIPTION OF THE INVENTION

Hereinafter, preferred embodiments of the invention are described in detail with reference to the accompanying drawings.

### First Embodiment

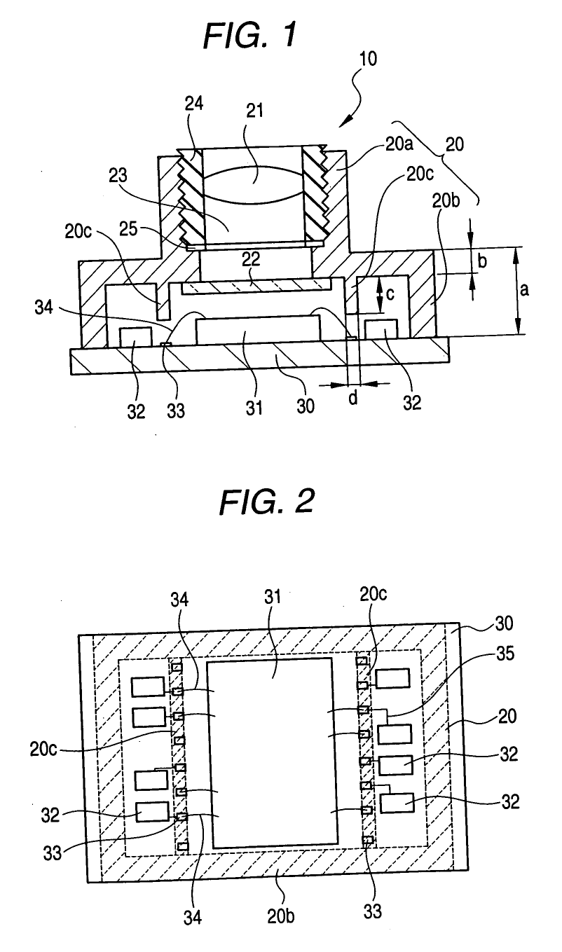

FIG. 1 is a cross-sectional view illustrating the configuration of a first embodiment of an image pickup module 10 according to the invention. The image pickup module 10 includes a holder 20 adapted to support a light receiving lens 21 and an infrared ray cut glass filter 22, and also includes a substrate 30 on which an image pickup element 31 and a chip component 32 are mounted.

A body of the holder 20 includes a cylindrically formed barrel portion 20a adapted to hold the light receiving lens 21, and also includes a casing portion 20b, whose shape in plan view is rectangular, adapted to hermetically seal one surface of the substrate 30, on which the image pickup element 31 is mounted.

The light receiving lens 21 is supported by an attachment 24 formed like a barrel. The attachment 24 is screwed into the barrel portion 20a and is supported by the holder 20 via a spacer 25. The glass filter 22 is bonded to the inner surface of a part of the casing portion 20b, which is the connecting part between the barrel portion 20a and the casing portion 20b, to face the light receiving lens 21 and to hermetically seal an opening hole 23 of the barrel portion 20a.

Further, the substrate 30 is bonded to an opening end part of the casing portion 20b, the inside of which is hermetically sealed space formed by closing an opening portion with the glass filter 22 and the substrate 30. The position of the substrate 30 is adjusted to an end surface of the casing portion 20b, and then, the substrate 30 is bonded thereto. Thus, the light receiving surface of the image pickup element 31 mounted on the substrate 30 is disposed to face the glass filter 22 and is aligned with an optical axis of the light receiving lens 21.

The image pickup module according to the present embodiment features that partitioning walls 20c are provided on the casing portion 20b of the holder 20 along the outer peripheral surfaces of the image pickup element 31. The partitioning walls 20c are provided to project from the inner surface of the casing portion 20b toward the substrate 30. In this embodiment, the partitioning walls 20c are provided to project from the vicinity of the base part of the barrel portion 20a toward the substrate 30.

The partitioning walls 20c are adapted to suppress dust, which remains in the holder 20, from going to the light receiving surface (the surface facing the glass filter 22) of the image pickup element 31, and also adapted to suppress dust from moving from the peripheral part of the casing portion 20b, that is, outer regions of a region, in which the image pickup element 31 is disposed on the substrate 30, toward the image pickup element 31.

FIG. 2 shows a plan view illustrating the substrate 30, taken from the surface on which the image pickup element 31 is mounted. In the image pickup module 10 according to this embodiment, the image pickup element 31 is disposed on the central portion of the substrate 30. Chip components 32, such as a capacitor and a resistor, and connecting-electrodes 33 are disposed along both sides of the image pickup element 31. The image pickup element 31 is electrically connected to the connecting electrodes 33 by wire-bonding using bonding wires 34. The chip components 32 and the connecting electrodes 33 are electrically connected through wiring patterns 35 formed on the surface of the substrate 30.

In the image pickup module 10 according to this embodiment, the image pickup element 31 formed to have a width substantially equal to that of the substrate 30 is mounted on the substrate 30. Thus, the partitioning walls 20c are provided to traverse the casing portion 20b widthwise along the longitudinal side edges of the image pickup element 31, respectively. The partitioning walls 20c are used to suppress dust from adhering to the light receiving surface of the image pickup element 31. Thus, the partitioning walls 20c are provided to isolate and separate the light receiving surface of the image pickup element 31 from other regions. Further, the partitioning walls 20c are provided in such a manner as not to shield the light receiving surface of the image pickup element 31.

As the height (the extended length) of the partitioning walls 20c increases, the action of causing the partitioning walls 20c to prevent dust from entering the image pickup element 31 becomes more effective. In this embodiment, the image pickup element 31 is connected to the connecting electrodes 33 by wire-bonding. Thus, the height of the partitioning walls 20c is set at a value sufficient to the extent that the bonding wires 34 and the partitioning walls 20c are prevented from interfering with one another. For example, in FIG. 1, the height a of the casing portion 20b is 1.5 mm and the thickness b of the upper portion of the casing portion 20b is 0.5 mm, the height c of the partitioning walls 20c is 0.7 mm (the gap between the partitioning walls 20c and the substrate 30 is 0.3 mm) and the width d of the partitioning walls 20c is 0.4 mm. In a case where the image pickup element 31 is surface-mounted without employing bonding-wiring, the height of the partitioning walls 20c can be increased to the degree that the end portions of the partitioning walls 20c are brought into contact with or into substantial contact with the surface of the substrate 30. For example, the gap between the partitioning walls 20c and the substrate 30 is preferably 0 to 0.2 mm, and such a structure can provide an advantage in that occurrences of troubles due to dust can effectively be prevented.

In a case where the substrate 30 is bonded to the open end surface of the casing portion 20b of the holder 20 and where the image pickup element 31 and various chip components 32 are hermetically sealed in the casing portion 20b, as illustrated in FIG. 6 showing the configuration of the related-art image pickup module 11, the image pickup element 31 and the chip components 32 are accommodated in a common space in the casing portion 20b. Therefore, in a case where dust adheres to the substrate 30, the dust easily moves to the image pickup element 31, so that the dust may adhere to the surface of the image pickup element 31.

Especially, in a case where many chip components 32 are mounted on the substrate 30, and many connecting electrodes 33 are formed thereon, so that the substrate 30 has a complicated structure, dust easily adheres to the substrate 30. Moreover, the dust having adhered to the substrate 30 is difficult to remove. Thus, dust having adhered to the components is liable to remain. When the image pickup module 11 is fabricated, in a state in which the fabricated image pickup module 11 is assembled to an electronic device, dust having adhered to the substrate 30 may be separated from the substrate 30 and move and adhere to the surfaces of the image pickup element 31 and the glass filter 22.

By contrast, the image pickup module 10 according to this embodiment is configured so that a component mounting region of the substrate 30, in which dust is highly likely to adhere and remain, separated by the partitioning walls 20c, which are provided in the holder 20, from the image pickup element 31. Thus, even in a case where dust is separated from the substrate 30 and moves in the casing portion 20b, dust can be suppressed from moving into a region in which the image pickup element 31 is disposed. Consequently, dust can be prevented from adhering to the light receiving surface of the image pickup element 31. Also, a defective product can be prevented from being produced due to the dust adhering to the light receiving surface of the image pickup element 31.

Incidentally, although the partitioning walls 20c are provided in the aforementioned embodiment to traverse the casing portion 20b of the holder 20 widthwise, the placement of the partitioning walls 20c is not limited to the example thereof in the aforementioned embodiment and can appropriately be selected. For example, a method of providing partitioning-walls 20c along the side edge portions of the image pickup element 31 to surround the image pickup element 31, and a method of arranging the partitioning walls 20c like a grid, or providing the partitioning walls 20c to partitioning the inside of the casing portion 20b into a plurality of small regions to prevent the movement of dust as much as possible are effective may be used.

The holder 20 is formed by integral resin molding. Thus, this embodiment has advantages in that even in a case where the partitioning walls 20c are provided in the holder 20, the partitioning walls 20c can easily be formed by resin molding, in that the image pickup module can be manufactured without changing a related-art manufacturing process, and in that the deign of the partitioning walls 20c can appropriately be changed according to those of products of image pickup modules. The partitioning walls 20c may be provided to the substrate 30.

### Second Embodiment

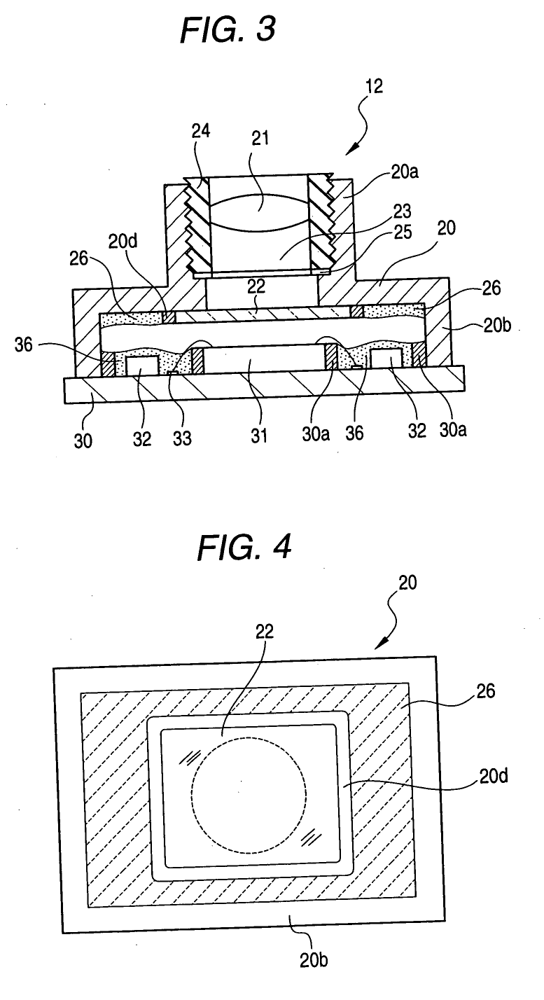

FIGS. 3 to 5 show the configuration of a second embodiment of the image pickup module according to the invention. The configurations of the body of a holder 20 and a substrate 30 in an image pickup module 12 according to this embodiment are similar to those of the holder 20 and the substrate 30 in the related-art image pickup module 11 in FIG. 6, respectively. That is, the body of the holder 20 of the image pickup module 12 according to this embodiment includes a barrel portion 20a and a casing portion 20b. An image pickup element 31 and a chip component 32 are mounted on the substrate 30.

Further, a light receiving lens 21 is held by the barrel portion 20a of the holder 20. A glass filter 22 is sealed to the connecting portion provided between the barrel portion 20a of the holder 20 and the casing portion 20b to block up an opening hole 23 of the barrel portion 20a from the inner surface of the casing portion 20b. The image pickup element 31 and the connecting electrodes 33 which are mounted on the substrate 30 are connected to one another by wire-bonding. This configuration is similar to that of the image pickup module 10 according to the first embodiment.

The image pickup module 12 according to the second embodiment features that a resin 26 is potted on the periphery of the glass filter 22 sealed to the inner surface of the casing portion 20b, and that the inner surface (the surface on which the glass filter 22 is mounted) of the casing portion 20b of the holder 20 is tightly sealed by the resin 26.

FIG. 4 shows a state of the holder 20, which is viewed from the side of the surface on which the glass filter 22 is mounted. A rectangular support frame 20d used to catch the peripheral edge portion of the glass filter 22 to position the glass filter 22 to be caught in the holder 20 is provided on the inner surface of the casing portion 20b. The potting of the resin 26 is potted in a region surrounded by the support frame 20d and the side plates of the casing portion 20b. In this embodiment, the support frame 20d also acts as a dam serving to stop the flow of the resin 26.

Further, regarding the substrate 30, this embodiment features that as shown in FIG. 3 the chip components 32 mounted on the substrate 30, excepting the image pickup element 31 mounted thereon, are sealed with a resin 36. The resin 36 is potted on the substrate 30. The chip components 32 and the connecting electrodes 33 are buried in the resin 36.

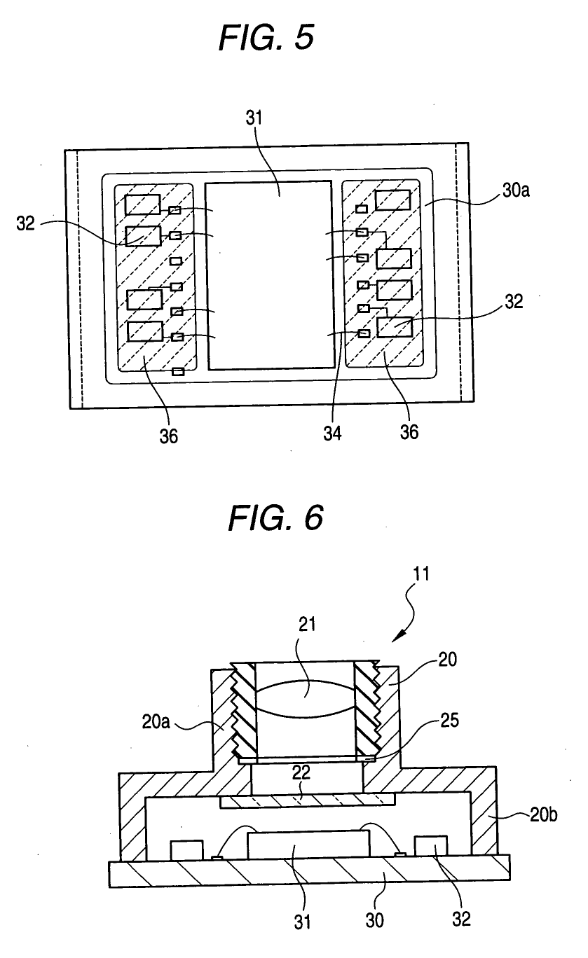

FIG. 5 shows a plan view of the substrate 30. A flow-stopping frame 30a is provided to surround the periphery of the image pickup element 31 and the region on which the chip components 32 are mounted. The resin 36 is potted on the inside of the flow-stopping frame 30a.

In the image pickup module 12 according to this embodiment, the inner surface (the surface of the casing portion 20b, on which the glass filter 22 is sealed) of the casing portion 20b of the holder 20 is sealed with the resin 26. Thus, dust adhering to the inner surface of the casing portion 20b is sealed off by the resin 26. In a case where the image pickup module 12 is assembled, dust can be prevented from being separated or falling from the casing portion 20b. Thus, this embodiment can solve the problem that dust adheres to the surface of the image pickup element 31.

Even in a case where the structure of the support frame 20d formed on the inner surface of the casing portion 20b of the holder 20 is relatively complicated, and where dust adhering to the structure remains, the dust can be prevented from being separated from the casing portion and thus, occurrences of troubles due to dust can be prevented, by sealing such a structure with the resin 26. Even though dust may be accumulated in the corner parts of the casing can be prevented by sealing the casing portion 20b including the corner parts.

Further, regarding the substrate 30, the complex and complicated structural parts, such as the chip components 32, are covered with the resin 36. Thus, even when dust remains on these structural parts, the dust can be prevented from being separated from the components. Consequently, occurrences of troubles due to the dust can be prevented. In a case where the structure of the substrate 30 is complicated by mounting the chip components 32 thereon, it is difficult to completely remove dust. However, this embodiment employing the method of using the resin 36 to prevent dust from moving to the outside has an advantage in that occurrences of troubles due to dust can effectively be prevented.

Any resin material may be used as the resins 26 and 36, as long as the resin material can be applied to the surface by potting.

Also, resin materials, which are heat-hardened after potted, may be used as the resins 26 and 36. Resin materials, which are naturally hardened at room temperature, may be also used as the resins 26 and 36. In a case where a resin material, which has tackiness (stickiness) when the resin material is in a cured state, is employed as the resins 26 and 36, the movement of dust is hindered when dust is brought into contact with the resins 26 and 36. Consequently, occurrences of troubles due to dust can more effectively be prevented.

Incidentally, although both the holder 20 and the substrate 30 are sealed by using the resins 26 and 36 in the embodiment shown in FIG 3, the image pickup module may be adapted so that only one of the holder 20 and the substrate 30 is sealed with the resins 26 and 36. Further, both the method of sealing the holder 20 and/or the substrate 30 with the resins 26 and 36, and the method of providing the partitioning walls 20c in the holder 20, which method has been described in the description of the first embodiment, can be employed.

I/we claim:

1. An image pickup module comprising:
a holder including a casing portion and a barrel portion adapted to support a light receiving lens; and
a substrate, on which an image pickup element is mounted, attached to the casing portion of the holder in a state that a light receiving surface of the image pickup element is aligned with the light receiving lens,
wherein a partitioning wall adapted to partition a region, on which the image pickup element is mounted, on the substrate from an outer region is provided in at least one of the holder and the substrate.

2. The image pickup module according to claim 1, wherein the partitioning wall is extended from an inner surface of the casing portion toward the substrate.

3. The image pickup module according to claim 1, further comprising:
an infrared ray cut filter provided on an inner surface of the casing portion by being placed to face the light receiving lens and to seal an opening hole of the barrel portion,
wherein the partitioning wall is disposed outside a region in which the filter is placed.

4. The image pickup module according to claim 1, wherein the partitioning wall partitions the outer region of the region, on which the image pickup element is mounted, into a plurality of regions.

5. An image pickup module comprising:
a holder including a casing portion and a barrel portion adapted to support a light receiving lens;
a substrate, on which an image pickup element is mounted, attached to the casing portion of the holder in a state that a light receiving surface of the image pickup element is aligned with the light receiving lens; and
wherein an inner surface of the casing portion is sealed with a resin.

6. The image pickup module according to claim 5, wherein a resin material having stickiness is used as the resin used for sealing.

7. The image pickup module according to claim 5, wherein an outer region of a region on which the image pickup element is mounted, on the substrate is sealed with a resin.

8. An image pickup module comprising:
a holder including a casing portion and a barrel portion adapted to support a light receiving lens; and
a substrate, on which an image-pickup element is mounted, attached to the casing portion of the holder in a state that a light receiving surface of the image pickup element is aligned with the light receiving lens,
wherein an outer region of a region on which the image pickup element is mounted, on the substrate is sealed with a resin.

9. The image pickup module according to claim 8, wherein a resin material having stickiness is used as the resin used for sealing.

10. The image pickup module according to claim 8, wherein a partitioning wall adapted to partition a region, on which the image pickup element is mounted, on the substrate from an outer region is provided in the holder.
